(19) United States
(12) Patent Application Publication
(10) Pub. No.: US 2013/0019484 A1
(43) Pub. Date: Jan. 24, 2013

(54) Extendable Comfort Razor

(71) Applicants: Kathy Allen, Rogue River, OR (US); Myles Mccrocklin, Kiamath Falls, OR (US); Laura Miller, Cache, OK (US)

(72) Inventors: Kathy Allen, Rogue River, OR (US); Myles Mccrocklin, Kiamath Falls, OR (US); Laura Miller, Cache, OK (US)

(21) Appl. No.: 13/184,785

(22) Filed: Jul. 18, 2011

(51) Int. Cl. B26B 21/52

(52) U.S. Cl. 30/526

(57) ABSTRACT

An extendable comfort razor comprising: an elongated body, where the elongated body extends the length of the extendable comfort razor; a handle at a top end of the elongated body, where the handle curves from the elongated body; a razor portion attached to a bottom end of the elongated body, where the razor portion slides in and out of the elongated body and where the razor portion receives a replacement cartridge; a set of adjustment notches along a middle portion of the elongated body; and a set of buttons along the razor portion wherein at least one of the buttons engage at least one of the adjustment notches to lock the elongated body at a desired length thereby allowing the replacement cartridge to reach a desired portion on a body of a user.

### BACKGROUND OF THE INVENTION

1. Field of the Invention

The present invention relates to shaving device to assist a user when reaching for distant portions of their bodies without extensive bending or stretching.

2. Description of Related Art

Presently, consumers have a variety of options when choosing a shaving razor. Some men prefer the old fashioned style shave from a straight razor, either purchasing a shave from a barber or owning their own equipment for an at-home, close facial shave. On the other hand, many individuals like the convenience of disposable or replacement cartridge razors wherein once the blade becomes dull, no sharpening is necessary, the user simply throws away the entire blade or cartridge after use. With the disposable razors the options range from razors designed specifically for men or women to those with vibrating handles to some with 3, 4 and even 5 blades. While the consumer has a wide array to choose from, the basics of the razor are essentially the same; a six inch handle to support an intersecting multi-blade razor.

Commonly, when using the typical disposable razor the user bends and twists their bodies to shave all of their desired body parts. This may become difficult or even painful for those with limited mobility especially when attempting to shave their legs. Also, people requiring total body shaves, like athletes participating in swimming, cycling or body building, often have difficulty reaching certain areas. Many times they require assistance from another individual to shave their back sides because they simply cannot reach with the standard six inch handle.

To address the problem of hard to reach areas, some shaving devices have recently been developed. For example, U.S. Pat. No. 5,167,069 by Kathleen H. Quinn discloses a razor reach wherein a razor is attached to the end of a telescoping handle. The handle twists to extend the blade which rests on a pivoting end. Additionally, U.S. Pat. No. 6,915,580 by Lisa L. Dassel discloses an extendable razor handle assembly wherein a razor is attached to the end of a telescoping extending body. The body includes a looped handlebar for the user to wrap around their wrist while shaving. While both of these razors are convenient for their extension feature, there is concern that the twisting handle may move during use, or that the looped handlebar is more interfering than helpful.

It would be desirable in the art to provide an extendable razor that easily extends and retracts while also providing a comfortable handle for the user. It would also be beneficial in the art to provide an extendable razor that locks in place to ensure that the length remains stationary during use.

### SUMMARY OF THE INVENTION

In view of the foregoing disadvantages inherent in the prior art, the general purpose of the present invention is to provide an extendable comfort razor, configured to include all of the advantages of the prior art, and to overcome the drawbacks inherent therein.

Accordingly, an object of the present invention is to provide an extendable razor that includes a comfort grip handle for a comfortable feel in a user's hand.

Another object of the present invention is to provide an extendable razor with an angled handle for optimal blade positioning while the user is shaving.

Yet another object of the present invention is to provide an extendable razor with an extension feature that allows the body portion to lock in place when the desired lengths are obtained.

To achieve the above objects, in an aspect of the present invention, an extendable comfort razor is described comprising: an elongated body, where the elongated body extends the length of the extendable comfort razor; a handle at a top end of the elongated body, where the handle curves from the elongated body; a razor portion attached to a bottom end of the elongated body, where the razor portion slides in and out of the elongated body and where the razor portion receives a replacement cartridge; a set of adjustment notches along a middle portion of the elongated body; and a set of buttons along the razor portion wherein at least one of the buttons engage at least one of the adjustment notches to lock the elongated body at a desired length thereby allowing the replacement cartridge to reach a desired portion on a body of a user.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of an extendable comfort razor in accordance with an exemplary embodiment of the present invention.

### DETAILED DESCRIPTION OF THE DRAWINGS

The present invention relates to shaving device to assist a user when reaching for distant portions of their bodies without extensive bending or stretching. The present invention provides an extendable comfort razor wherein the body portion extends and retracts to facilitate shaving. The body extends between a comfort grip handle and a razor to allow the user to set their optimal length while shaving hard to reach areas. Additionally the extendable comfort razor locks at the desired length to ensure that the body does not slide or shift during use, therefore providing the user with not only a comfortable shave but also a safe shave.

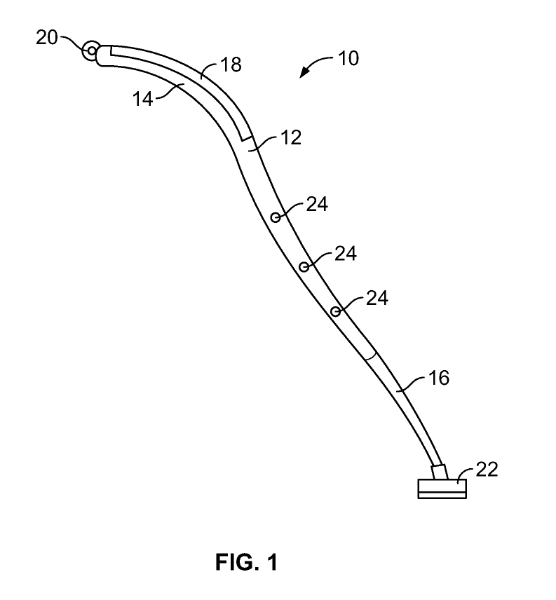

Turning now descriptively to the drawings, referring to FIG. 1, an extendable comfort razor (10) is shown in accordance with an exemplary embodiment of the preset invention. The extendable comfort razor (10) includes an elongated body (12) that extends the entire length of the extendable comfort razor (10). The elongated body (12) stretches between a handle (14) at a top end and a razor portion (16) attached at a bottom end. The elongated body (12) may be tubular to allow for a lighter weight and easier maneuverability. Alternatively, the elongated body (12) may comprise an elongated U-shape, wherein the top and sides resemble a U when looking down the end or shaft of the elongated body (12), and there is no backing to close the shape into a tube. The elongated body (12) may be made from a lightweight plastic material or a non-rusting metallic material. Both materials are able to withstand being in a wet or damp environments, because shaving razors are typically used in a bathroom, bathtub or shower. The elongated body (12) may comprise a curved, upside-down, L-shape wherein the handle (14) curves at an ergonomic angle from the elongated body (12). This way the handle (14) is placed in the most physiologically comfortable angle for the user. The handle (14) angle may range from 180°-90°, but preferably around 135°.

The handle (14) may include an enhanced gripping material (18) to assist a user when holding the extendable comfort razor (10). The enhanced gripping material (18) may be a rubber, gel, plastic or like material. Also, the enhanced gripping material (18) may include a textured surface for additional handling assistance for the user which is especially useful in slippery shaving conditions. At the end of the handle (14) may be a loop (20). The loop (20) enables the user to hang the extendable comfort razor (10) from a hook in the bathroom or from the user's wrist during use. The loop (20) may be a circular or oval piece of plastic or alternatively a piece of nylon rope or string.

The razor portion (16), attached to the lower end of the elongated body (12), may receive a replacement cartridge (22). The replacement cartridge (22) assembles the blades for the extendable comfort razor (10). The replacement cartridge (22) snaps onto the end of the razor portion (16) and then is easily removed when the replacement cartridge (22) becomes dull. The replacement cartridge (22) may be available is multi-sets wherein 4-6 blades are packaged together for convenient replacement. The replacement cartridge (22) may be available in various widths to accommodate differing shaving styles desired by the user. For example, a wide blade cartridge is used to shave a large area like a shin or thigh, while a narrow blade cartridge is used to trim an area like a beard or bikini zone.

In the middle portion of the elongated body (12) may be a set of adjustment notches (24). Likewise a set of engaging buttons are fastened to the razor portion (16). The adjustment notches (24) enable razor portion (16) to extend and retract from the elongated body (12), thus extending and shortening the length of the extendable comfort razor (10). As the razor portion (16) retracts into the elongated body (12), one or more of the engaging buttons slide into one or more of the adjustment notches (24) to lock the extendable comfort razor (10) at the desired length. To unlock the extendable comfort razor (10) the user simply presses one or more of the buttons back through one or more of the notches (24) to release them and allow the razor portion (16) to slide. The length of the elongated body (12) may range from 10-36 inches, where the ideal length adjusts between 18 inches to 25 inches.

If the elongated body (12) comprises the U-shape the adjustment notches (24) may allow the razor portion (16) to bend from the elongated body (12) thereby offering the user an angled razor to extend to the hard to reach areas of the body. As such, the extendable comfort razor (10) enables the user to reach and shave portions of their body without extensive bending or reaching for an overall more comfortable shave.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An extendable comfort razor comprising:
an elongated body, where the elongated body extends the length of the extendable comfort razor;
a handle at a top end of the elongated body, where the handle curves from the elongated body;
a razor portion attached to a bottom end of the elongated body, where the razor portion slides in and out of the elongated body and where the razor portion receives a replacement cartridge;
a set of adjustment notches along a middle portion of the elongated body; and
a set of buttons along the razor portion wherein at least one of the buttons engage at least one of the adjustment notches to lock the elongated body at a desired length thereby allowing the replacement cartridge to reach a desired portion on a body of a user.

2. The extendable comfort razor according to claim 1, wherein the handle includes an enhanced gripping material to provide a comfortable grip for the user.

3. The extendable comfort razor according to claim 2, wherein the enhanced gripping material is one of at least rubber, plastic and gel.

4. The extendable comfort razor according to claim 1, wherein the handle includes a loop to hang the extendable comfort razor.

5. The extendable comfort razor according to claim 1, wherein the elongated body is tubular.

6. The extendable comfort razor according to claim 1, wherein the elongated body comprises an elongated U-shape.

7. The extendable comfort razor according to claim 6, wherein the U-shaped elongated body along with the set of notches enable the razor portion to bend from the elongated body.

8. The extendable comfort razor according to claim 1, wherein the elongated body comprises a curved, upside down, L-shape.

9. The extendable comfort razor according to claim 1, wherein the set of adjustment notches enable the length of the elongated body to adjust from 18 inches to 25 inches.

10. The extendable comfort razor according to claim 1, wherein the replacement cartridge is wide to shave a large area on the body of the user.

11. The extendable comfort razor according to claim 1, wherein the replacement cartridge is narrow to trim a small area on the body of the user.
